(19) United States
(12) Patent Application Publication
(10) Pub. No.: US 2026/0115687 A1
(43) Pub. Date: Apr. 30, 2026

(54) ATMOSPHERIC CARBON DIOXIDE SORBENT

(71) Applicant: Robert Bosch Gmbh, Stuttgart (DE)

(72) Inventors: Dina KUSSAINOVA, Princeton, NJ (US); Daniil A. KITCHAEV, Newton, MA (US)

(21) Appl. No.: 18/931,696

(22) Filed: Oct. 30, 2024

(51) Int. Cl. B01J 20/26; B01D 53/14

(52) U.S. Cl. CPC B01J 20/261; B01D 53/1475; B01D 2252/20421; B01D 2252/20426; B01D 2257/504

(57) ABSTRACT

A CO₂ sorbent includes a polymeric repeating unit having a backbone and at least one sidechain, the at least one sidechain comprising an amine having an alpha carbon adjacent an amine group, a covalently-bonded linkage between the alpha carbon and the backbone, and one or two hydrogen substituents on the alpha carbon, the substituents including a halogen, a hydroxyl group, a carboxyl group, an amine group, or a combination thereof, the sorbent being structured to reversibly bind CO2.

### TECHNICAL FIELD

The present disclosure relates to a sorbent for capture of atmospheric carbon dioxide (CO₂) and a method of making and using the same.

### BACKGROUND

Carbon dioxide is a notorious greenhouse gas whose emissions have been sharply on the rise since the Industrial Revolution began in the 18^{th} century. Since then, the CO₂ emissions have been a confirmed culprit in the climate change around the world. Recent findings of the International Panel on Climate Change have proposed that the CO₂ emissions should be halved by 2030 to avoid further negative impact on the planet. Various technologies have been developed to capture atmospheric CO₂, but their drawbacks prevent realization of more widespread CO₂ sequestration from air.

### SUMMARY

In at least one embodiment, a CO₂ sorbent is disclosed. The CO₂ sorbent may be a direct air capture (DAC) sorbent. The sorbent may include a polymeric repeating unit having a backbone and at least one sidechain, the at least one sidechain comprising an amine having an alpha carbon adjacent an amine group, a covalently-bonded linkage between the alpha carbon and the backbone; and one or two hydrogen substituents on the alpha carbon, the substituents including a halogen, a hydroxyl group, a carboxyl group, an amine group, or a combination thereof. The sorbent may be structured to reversibly bind CO₂. The sidechain may include one substituent on the alpha carbon. The one or two hydrogen substituents may include a carboxyl group. Both substituents may have a same chemical composition. The covalently-bonded linkage may include a carbon bonded to the alpha carbon. The covalently-bonded linkage may include a benzene ring. The amine may be a primary amine. The amine may be a secondary amine having two alpha carbons such that each alpha carbon includes one or two of the hydrogen substituents.

In at least one embodiment, a CO₂ capture system is disclosed. The system may include a container having a fluid input; a fluid output, the fluid including CO₂; and a sorbent structured to bind CO₂ from the fluid. The sorbent may have a backbone and a sidechain including an amine with at least one alpha carbon adjacent an amine group and one or two hydrogen substituents on the alpha carbon, the substituents including a halogen, a hydroxyl group, a carboxyl group, an amine group, or a combination thereof. The sidechain may include one substituent on the at least one alpha carbon. The one or two hydrogen substituents may include a carboxyl group. The sidechain may include two hydrogen substituents, both substituents having a same chemical composition. The sidechain may include two hydrogen substituents, one substituent including a methyl group and a second substituent including a carboxyl group. The amine may be a primary amine. The amine may be a secondary amine having two alpha carbons such that each alpha carbon includes one or two of the hydrogen substituents.

In at least one embodiment, a CO₂ capture sorbent is disclosed. The sorbent may include a polymeric repeating unit having a backbone and at least one sidechain. The at least one sidechain may include an amine having an alpha carbon adjacent an amine group, the alpha carbon having one or two hydrogen substituents including a halogen, a hydroxyl group, a carboxyl group, an amine group, or a combination thereof. The sorbent may be structured to reversibly bind CO₂. The sidechain may include one substituent on the alpha carbon, the substituent being a carboxyl group. The sidechain may include two hydrogen substituents, both substituents having a same chemical composition. The amine may be a primary amine. The amine may be a secondary amine having two alpha carbons such that each alpha carbon includes one or two of the non-hydrogen groups.

### BRIEF DESCRIPTION OF THE DRAWINGS

FIG. 1 is a schematic depiction of a non-limiting example direct-air-capture (DAC) system with CO₂ sorption into a solid sorbent and sorbent regeneration;

FIG. 2 is a schematic illustration of reactions taking place during amine-based resin degradation;

FIGS. 3A-3T show prior art and modified polymeric sorbents with side chain structures assessed for degradation and CO₂ binding energy;

FIG. 4 shows results of the prior art and modified polymeric sorbents of FIGS. 3A-3T screening according to (a) CO₂ binding energy;

FIG. 5 shows results of the prior art and modified polymeric sorbents of FIGS. 3A-3T screening according to (b) stability of a key degradation intermediate, peroxide;

FIG. 6 shows results of the prior art and modified polymeric sorbents of FIGS. 3A-3T screening according to (c) the activation energy of the first degradation step;

FIG. 7A is a plot of Hirshfeld charge of the carbon atom next to the amine group in prior art and modified sorbents, according to one or more embodiments disclosed herein, as a function of (a) the activation energy of the degradation;

FIG. 7B is a plot of Hirshfeld charge of the carbon atom next to the amine group in prior art and modified sorbents, according to one or more embodiments disclosed herein, as a function of (b) stability of a key degradation intermediate, peroxide;

FIG. 7C is a plot of Hirshfeld charge of the carbon atom next to the amine group in prior art and modified sorbents, according to one or more embodiments disclosed herein, as a function of (c) CO₂ binding energy; and

FIGS. 8A 8B, and 8C are non-limiting examples of amine-functionalized sidechain monomer units according to one or more embodiments disclosed herein.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word “about” in describing the broadest scope of the disclosure. Practice within the numerical limits stated is generally preferred. Also, unless expressly stated to the contrary: percent, “parts of,” and ratio values are by weight; the description of a group or class of materials as suitable or preferred for a given purpose in connection with the disclosure implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed. Unless stated otherwise, the wt.% is based on the total weight of the substrate and the vol.% is based on the total volume of the substrate.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

As used herein, the term “substantially,” “generally,” or “about” means that the amount or value in question may be the specific value designated or some other value in its neighborhood. Generally, the term “about” denoting a certain value is intended to denote a range within +/- 5% of the value. As one example, the phrase “about 100” denotes a range of 100+/- 5, i.e. the range from 95 to 105. Generally, when the term “about” is used, it can be expected that similar results or effects according to the disclosure can be obtained within a range of +/- 5% of the indicated value. The term “substantially” may modify a value or relative characteristic disclosed or claimed in the present disclosure. In such instances, “substantially” may signify that the value or relative characteristic it modifies is within ± 0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . ., 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. Similarly, whenever listing integers are provided herein, it should also be appreciated that the listing of integers explicitly includes ranges of any two integers within the listing.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

As used herein, the term “and/or” means that either all or only one of the elements of said group may be present. For example, “A and/or B” means “only A, or only B, or both A and B”. In the case of “only A,” the term also covers the possibility that B is absent, i.e. “only A, but not B”.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The term “comprising” is synonymous with “including,” “having,” “containing,” or “characterized by.” These terms are inclusive and open-ended and do not exclude additional, unrecited elements or method steps. The term “including” or “includes” may encompass the phrases “comprise,” “consist of,” or “essentially consist of.”

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed subject matter can include the use of either of the other two terms.

The term “one or more” means “at least one” and the term “at least one” means “one or more.” The terms “one or more” and “at least one” include “plurality” as a subset.

The description of a group or class of materials as suitable for a given purpose in connection with one or more embodiments implies that mixtures of any two or more of the members of the group or class are suitable. Also, the description of a group or class of materials as suitable for a given purpose in connection with one or more embodiments implies that the group or class of materials can “comprise,” “consist of,” and/or “consist essentially of” any member or the entirety of that group or class of materials. First definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Carbon dioxide or CO₂ is a primary greenhouse gas accounting for about 80% of all U.S. annual greenhouse gas emissions from human activities. The CO₂ emissions are a well-recognized global problem. Greenhouse gasses are gasses that trap heat in the atmosphere. The heat trapping causes changes in the radiative balance of the Earth that alter climate and weather patterns at global and regional scales. CO₂ is a chemical compound made up of molecules that each have one carbon atom covalently double bonded to two oxygen atoms. CO₂ is found in the gas state at ambient temperature. In the air, CO₂is transparent to visible light but absorbs infrared radiation, thereby acting as a greenhouse gas. CO₂ enters the atmosphere through burning of fossil fuels such as coal, natural gas, and oil, solid waste, trees, and other biological materials. CO₂further enters the atmosphere as a result of certain chemical reactions such as manufacturing of cement or aluminum. Additionally, when methane enters the atmosphere, it combines with oxygen to form CO₂.

Because of its negative impact on the global climate, efforts have been made to reduce CO₂ emissions, mostly by capture of CO₂ at the source of release such as from smokestacks of power plants, cement plants, or aluminum plants. Yet, much of the man-made CO₂ emissions cannot be captured at the source such as those originating from cars or airplanes. Additionally, capture of the already released CO₂, so called legacy CO₂, is highly desirable to reduce the overall climate impact of the CO₂ greenhouse gas.

Hence, the extraction of CO₂ from ambient air is a potential route for the mitigation of greenhouse gas emissions and associated climate change. The direct extraction of CO₂ from air via a sorbent, typically termed direct air capture (DAC), is the gold-standard technology for this objective.

A typical sorbent technology in DAC includes a porous support material functionalized with amine-containing molecules or polymers. For example, a porous silica or cellulose support material may be functionalized with amine-containing molecules or polyethyleneimine (PEI). In this type of sorbent, the amines react spontaneously with CO₂ to separate the CO₂from the air while the porous support material provides a high surface area for the amine/air interface, ensures thar the air can flow through the sorbent, and anchors the amines in the solid sorbent, preventing their volatilization.

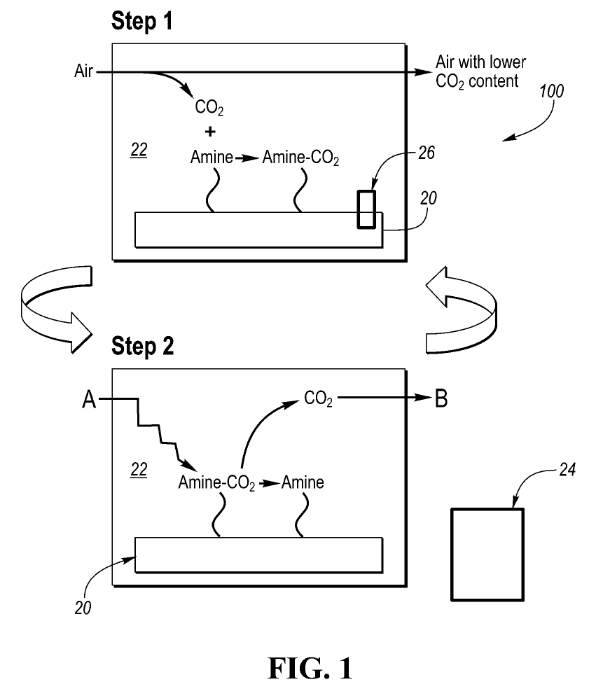

A non-limiting example DAC sorption system/process includes two steps, shown schematically in FIG. 1. As can be seen in FIG. 1, in the first stage or step 1, a sorbent 20 chosen to selectively absorb CO₂ is exposed to air until it reaches a desired saturation point. In the first step of FIG. 1, air is passed over an amine-functionalized sorbent 20, which separates CO₂ from the incoming gas stream, denoted as air. In the second stage or step 2, the sorbent is regenerated by stripping the absorbed CO₂ from the sorbent 20 and storing the captured CO₂ at high pressure and purity for later utilization or sequestration, marked as B. In the second step, the CO₂ bound to the solid sorbent 20 is detached using a change in temperature, pressure, humidity level, or other stimulus, marked as A, regenerating the sorbent to its pristine state and releasing the CO₂ for storage or utilization. The process can then be repeated. In the schematic, the line connecting “amine” to “porous support” denotes that the amines are chemically bonded to the support.

While the first stage of this process is spontaneous, as the sorbent chemistry is chosen to react favorably with CO₂, the regeneration stage requires energy input to desorb the captured CO₂. The energy may come in the form of heat, changes in external pressure, changes in humidity, changes in potential, or washing with an exchange or transfer fluid having a component with preferential affinity towards CO₂.

The energy cost of the DAC process, as well as the useful life of the sorbent material, are largely determined by the efficiency of the regeneration stage, making it an important design component of any DAC process. The cost of the DAC process is largely dependent on the amount of CO₂ which the sorbent can take up in a set amount of time, the degradation rate of the sorbent material, and the energy input required to release the captured CO₂ during the regeneration stage.

Amine-functionalized solid sorbents are generally hydrophilic and absorb water alongside CO₂ with the amount and structure of absorbed water dependent on ambient conditions such as humidity and temperature, as well as the type of sorbent material used. Some water is absorbed in the bulk of the polymer at low humidity, but most of the water absorption occurs by capillary condensation in the micropores at medium-to-high humidity. The exact humidity value for condensation depends on the size of the micropores, with larger micropores more resistant to capillary condensation.

Hence, water co-adsorbed with the CO₂ plays a dual role in the DAC technology. Water molecules immediately adjacent to the amine groups can significantly accelerate the CO₂ adsorption process, increasing both the capture rate and overall capacity of the sorbent. However, water also adds to the thermal mass of the system, significantly increasing the energy required for sorbent regeneration. High water loading can also lead to gas transport limitations as the porosity of the sorbent resin becomes flooded. Finally, water content may affect the degradation rate of the sorbent. Therefore, water loading must be carefully balanced in an ideal sorbent to maximize the sorption benefits offered by the presence of water, while minimizing the added energy cost during regeneration, any potential impact on sorbent degradation and the transport problems induced by local flooding.

Additionally, the process conditions (temperature, pressure, gas composition) during CO₂ adsorption and regeneration can significantly affect the performance and lifetime of the sorbent. At elevated temperatures, the amine-based resin can undergo oxidative degradation that significantly reduces its lifespan. Due to the severe impact of oxidative degradation on the performance of the DAC process, sorbent modifications capable of improving its resistance to oxidation are of high interest.

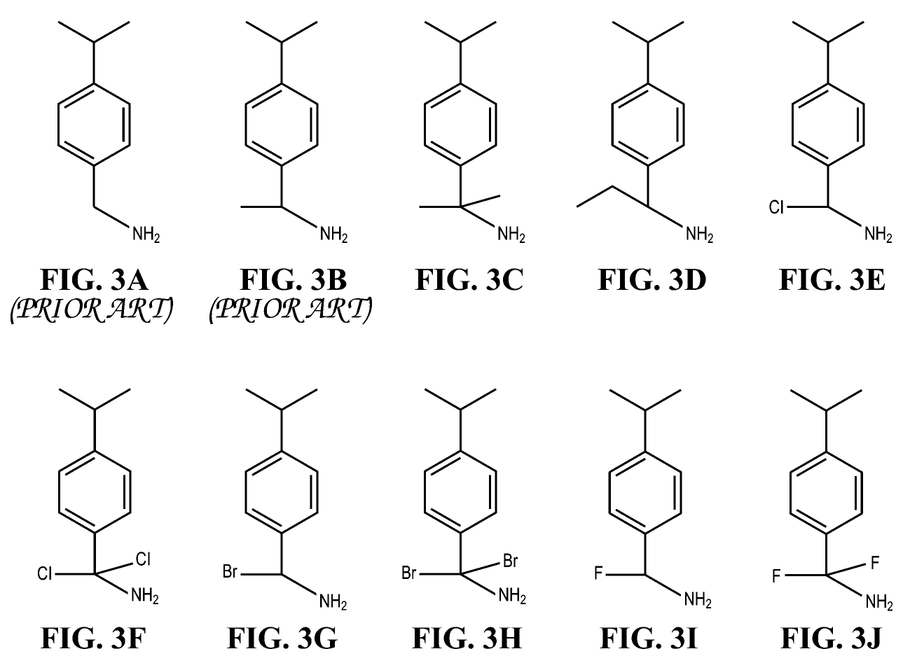

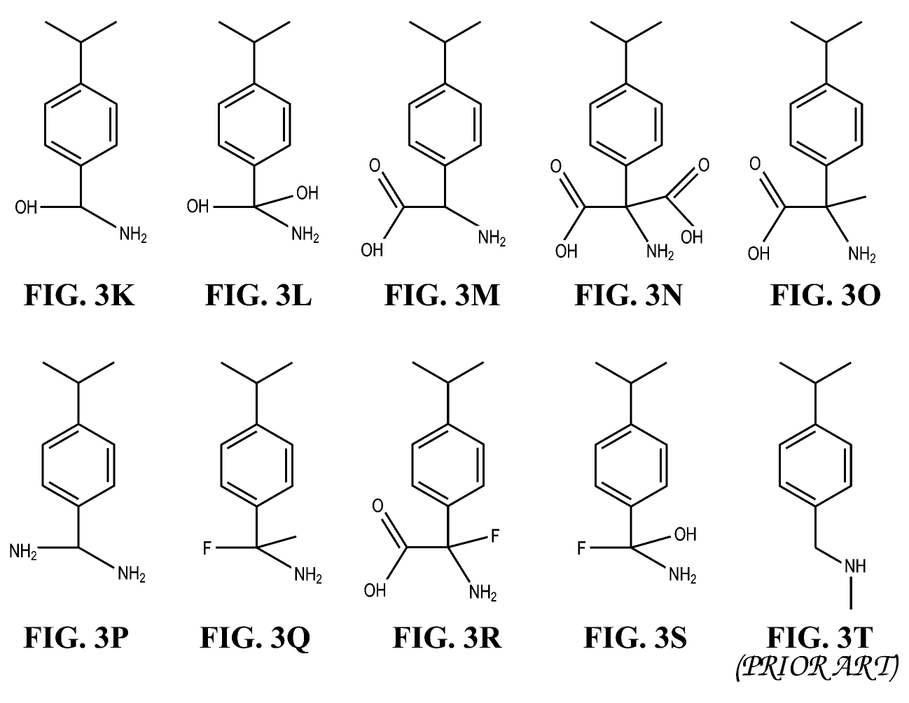

One way to improve the durability of a DAC sorbent has been the addition of a methyl group to the carbon atom adjacent to the amine, making alpha methylbenzylamine sorbent (depicted in FIG. 3A). This modification has been reported to slow down the degradation process by almost 35% compared to the original benzylamine sorbent under aggressive oxidation conditions. However, there is a need to identify optimal and additional sorbent modifications, which may be even more effective.

In one of more embodiments, a solid sorbent for CO₂ capture is disclosed. The sorbent is a solid sorbent with an optimized chemical structure. The optimized chemical structure results in (a) improved durability, thereby minimizing degradation of the sorbent and improving its lifespan, and (b) ability to effectively capture CO₂ while maintaining favorable interactions with water.

The sorbent may include one or more compounds or materials. The materials may be polymeric. The materials may be anion exchange resins. The material may include a backbone structure with at least one side chain facilitating chemisorption of CO₂. The backbone may include a thermoplastic resin such as polystyrene, polypropylene, polyethylene, polyvinyl chloride, polyethyleneimine, polypropyleneimine, polyallylamine, polyallyl, a natural, linear polymer such as cellulose, crystalline or amorphous materials such as silica, alumina, or the like. The backbone may be linear or branched. The polymer may include a high degree of crosslinking. The repeating monomer unit may be homogenous or heterogenous. The polymer may be a copolymer, thus including two or more types of repeating units. Each repeating unit may have the same or different substituents disclosed herein.

The at least one side chain may be amine-functionalized. The polymeric compound may thus be amine-functionalized. All of the side chains or less than all of the side chains may be amine-functionalized. The amine functionalization serves for reversible CO₂ binding for the DAC process described herein. The amines may include primary, secondary amines, or their combination. A primary amine is an amine having a single alkyl substituent bonded to a nitrogen atom, the remaining substituents being hydrogen atoms. A secondary amine is an amine having two alkyl substituents bonded to a nitrogen atom and one substituent being a hydrogen atom.

The primary or secondary amine includes a substitution of one or both hydrogens. The substitution is at the carbon adjacent the nitrogen of the primary or secondary amine, also called the alpha carbon. The alpha carbon may thus include one or two non-hydrogen groups, which substituted the one or two hydrogens. The substituent, non-hydrogen groups may include: carboxyl group, halogen, hydroxyl group, methyl group, amino group, or their combination. One or more of carboxyl group, halogen, hydroxyl group, methyl group, amino group may be excluded.

The substitution may be on the single alpha carbon of the primary amine, a single alpha carbon of the secondary amine, or at both alpha carbons of the secondary amine. Since both alpha carbons may represent an attack site for oxygen-induced degradation, substitution on both or all alpha carbons may decrease the rate of degradation. When the substitution is made on both alpha carbons of the secondary amine, the substitutions may include the same or different substituent chosen from the group named above.

The substituents are shown in FIGS. 3A-3T and feature groups including methyl, ethyl, halogen, hydroxyl, carboxyl, and their combinations. While the examples in FIGS. 3A-3T show the polymeric chain containing benzene, (1-methylethyl), the structure is only exemplary. The benzylamine was chosen to be referenced because that is the structure of the state-of-the-art sorbent material which was used as a bench mark in the Experimental section – FIGS. 3A, 3B, and 3T.

Other structures of the sidechain are contemplated such as including a carbon chain with single, double, or triple bonds, heterocyclic compounds, aliphatic compounds, or their combination. The alpha carbon may be thus attached, directly or indirectly, to a cyclic or aliphatic compound or the backbone or a compound within the side chain. The sidechain may thus be a molecule providing a covalently-bonded linkage between the alpha carbon and the polymer backbone. The alpha carbon may be bonded to another carbon rather than an oxygen, nitrogen, or other species as non-carbon species may likely add additional attack pathways, contributing to an accelerated degradation.

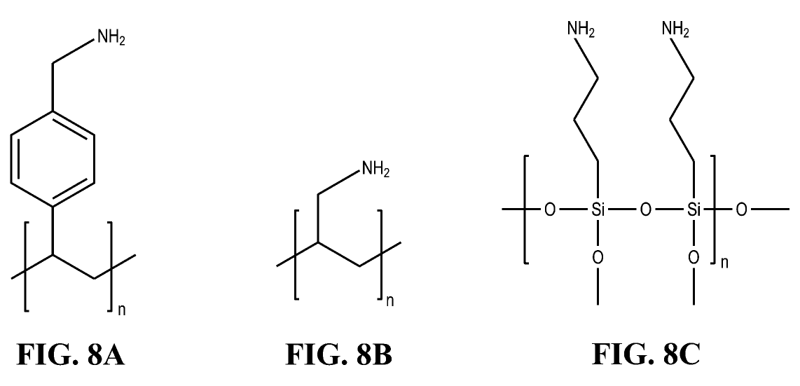

Three non-limiting example monomer units of a sorbent disclosed herein may include a functionalized polystyrene as shown in FIG. 8A, a simple linear hydrocarbon such as polyallylamine shown in FIG. 8B, or aminopropylsiloxane shown in FIG. 8C. In FIGS. 8A-8C, n means a number of monomer repeating units and depends on a specific application and type of resin. n is greater than 1.

Hence, the resin may include at least one sidechain with at least one alpha carbon having one or more hydrogen substitutions for a carboxyl group (-C(=O)-OH), halogen (-F, -Cl, -Br) hydroxyl group (-OH), methyl group (-CH₃), amino group (-NH₂), or their combination. In a non-limiting example, at least one or each alpha carbon may have one or more hydrogen substitutions for a carboxyl group (-C(=O)-OH), halogen (-F, -Cl, -Br), hydroxyl group (-OH), methyl group (-CH₃), amino group (-NH₂), or their combination.

In a non-limiting example, the alpha carbon includes two substitutions, both being carboxyl groups. In another non-limiting example, the alpha carbon includes only one substitution with a carboxyl group. In another non-limiting example, the alpha carbon includes two substitutions, both being halogen, specifically fluorines. In another non-limiting example, the alpha carbon includes only one substitution with a hydroxyl group. In another non-limiting example, the alpha carbon includes two substitutions, both being hydroxyl groups. In another non-limiting example, the alpha carbon includes two substitutions, one being a carboxyl group and the second being a methyl group. In another non-limiting example, the alpha carbon includes two substitutions, one being a carboxyl group and the second being a halogen (fluorine). In another non-limiting example, the alpha carbon includes only one substitution with an amine group.

The polymeric compounds may also include a rigid crosslinker molecule incorporated into the backbone, locking the backbone chains in place and preventing the chain compaction, thereby creating a permanent porosity in the material. Traditional crosslinkers may include divinylbenzene (DVB) or diphenylmethane crosslinked by the Friedel-Crafts reaction.

The sorbent may be a 3D structure having a solid portion and a porous portion. The porous portion may be distributed throughout the solid portion. The solid portion and the porous portion may form an internal volume of the sorbent. The sorbent may be formed into a variety of shapes, sizes, and configurations.

The sorbent may have multiple porosity including macropores (20-200 nm diameter), micropores (0.5-2 nm diameter), and mesopores (2-20 nm). The macropores may be configured to facilitate long-range diffusion of CO₂. The micropores and mesopores may form an interpenetrating network structured to facilitate CO₂ access to the interior volume of the sorbent.

The herein-disclosed sorbent may serve for DAC of CO₂ from dilute sources of CO₂ such as ambient air or from more concentrated sources of CO₂ such as flue gas or biogas. In a non-limiting example, the H substituents on the alpha carbon for sorbents for dilute CO₂ sources may include a single carboxyl group. A dilute source may be a source containing between about 0.01 and 0.1 % of CO₂. In another non-limiting example, the H substituents on the alpha carbon for concentrated CO₂ sources may include two substituents, each being a methyl group, halogen group, hydroxyl group, carboxyl group, or their combination. A concentrated source may be a source containing between about 0.1 and 20% CO₂.

A method of forming a sorbent for DAC of CO₂ capture is disclosed herein. The method may include forming a sorbent including a functional group configured to capture or bind CO₂ from air and immobilizing the functional group on a support material. The method may include polymerization including crosslinking of monomer units including compounds disclosed herein. The method may include forming monomer units utilizing H substituents on at least one alpha carbon as disclosed herein. The method may include chemical modification of the resin after polymerization to modify the amine and H-substituents on the polymer sidechains. The method may include tailoring the substituents depending on a use application. For example, the method may include choosing first substituents for dilute CO₂sources and second substituents for concentrated CO₂ sources, such as those disclosed above.

A method of using the herein-disclosed sorbent is disclosed herein. The method may include providing the sorbent in a DAC system. The method may include sorbing CO₂ within the sorbent until a predetermined CO₂ saturation point, value, or range. The method may include regenerating the sorbent by using an exchange fluid with affinity to CO₂, thermally, or otherwise.

The sorbent disclosed herein may be part of a system structured to sequester CO₂ from dilute or concentrated sources. The system may be a DAC system 100, such as that depicted schematically in FIG. 1. The system is arranged to capture CO₂ from air, atmosphere. The capture may be direct capture. The CO₂ may be anthropogenic CO₂, legacy CO₂, naturally produced CO₂, CO₂ from various sources such as decomposition CO₂, ocean release CO₂, respiration CO₂, industrial sources CO₂, deforestation CO₂, fossil fuel burning CO₂, transportation CO₂, fuel combustion CO₂, exhaust CO₂, flue gas CO₂, biogas CO₂, the like, or their combination.

The system 100 includes several components which cooperate mechanically, physically, chemically, fluidly, or a combination thereof. The system may include one more compartments 22 housing the porous sorbent, one or more mechanisms configured to regenerate the sorbent, one or more apparati for storage of the captured CO₂, one or more components for release of the outgoing air having a lower concentration of CO₂ than the incoming air, the like, or a combination thereof. The compartment may be a tank, vessel, container, canister, capsule, tub, chamber, cistern, flask, receptacle, or the like. The container may be a closed, enclosable, openable, sealable, and/or resealable container.

The compartments may include one or more air inputs structured as resealable or enclosable openings, one or more conduits connecting one or more portions of the system and arranged to lead one or more fluids between various portions of the system. The fluids may be air, exchange liquid(s), electrolyte(s), etc. The compartment may include one or more conduits to lead CO₂-free air from the compartment.

The system may utilize the solid porous sorbent in combination with a liquid exchange of transfer fluid having a chemical with preferential affinity for CO₂, configured to regenerate the sorbent after CO₂ is bound to the sorbent to a predetermined saturation point. The regeneration may be realized by mediated transport of CO₂ from the sorbent by removing, desorbing, stripping, or displacing CO₂ absorbed onto the sorbent, and binding the CO₂. Alternatively, the system may use heat, changes in external pressure, changes in RH to regenerate the porous sorbent. The system may thus include a heat source, pressure regulator(s), humidity control system, or the like.

The system may further include one or more controllers, sensors, or both, receiving or providing inputs and outputs to trigger binding of CO₂, release of CO₂ from the sorbent, regeneration of the sorbent, or a combination thereof. The controller(s) may thus monitor, adjust, initiate, terminate, or contribute to binding and/or release of the sorbent, for example by controlling, adjusting, monitoring RH of the system, subsystem, or cell which the sorbent is present in. Alternatively, controlled flooding may be secured by the structural features of the sorbent disclosed herein and may not need a controller’s assistance. Non-limiting examples of a controller 24 and sensor 26 are schematically depicted in the system shown in FIG. 1. The placement and configuration are just schematic and may differ from that depicted in FIG. 1.

### EXPERIMENTAL SECTION

### Strategy and considerations

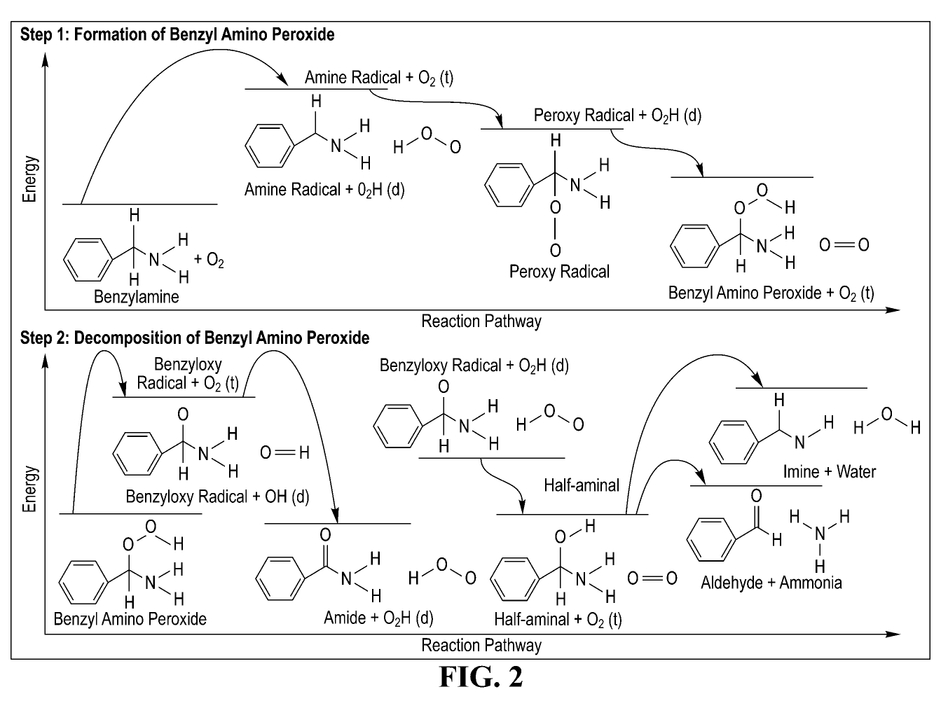

To identify an optimal sorbent with good sorption capabilities and good durability, reactions taking place during the amine-based resin degradation were assessed. FIG. 2 shows a schematic illustration of the reactions taking place during the amine-based resin degradation. As can be seen in FIG. 2, the sorbent degrades when exposed to oxygen through a fairly complicated pathway. The degradation process proceeds via a series of reactions representing two main steps: initial oxidation of the sorbent to form benzyl amino peroxides and subsequent thermal decomposition of peroxides into amide (R(C=O)NH₂), half-aminal (RCH(OH)(NH₂)), aldehyde (RCHO), and ammonia, as is illustrated in FIG. 2.

The oxidative degradation is initialized with physisorption of O₂ to the polymeric resin. One of the hydrogens on the carbon atom adjacent to the amine is abstracted from the sorbent, forming hydroperoxyl (O₂H) and benzylamine radicals. Another O₂ is used to produce a peroxy radical from the benzylamine radical, which subsequently reacts with O₂H to produce benzyl amino hydroperoxide and O₂. Benzyl amino hydroperoxides can subsequently undergo thermal decomposition, initially dissociating into the benzyloxy and hydroxyl (OH) radicals. In the presence of O₂, the benzyloxy radical can produce amide and hydroperoxyl radical. The hydroperoxyl radical can then react with another benzyloxy radical to produce a half-aminal. Finally, the half-aminal can decompose into aldehyde and ammonia, or imine and water. In this final step, the production of aldehyde with ammonia is the more likely path due to the lower activation barrier of this reaction. In summary, while oxidative degradation proceeds via a long series of reactions, the first reaction, hydrogen transfer from the sorbent to O₂, is rate-determining and can be used to control the whole degradation process. By modifying this step, the degradation process can be slowed down or vice versa.

The strategy to prevent or minimize the sorbent degradation is thus to prevent removal of H from the carbon adjacent the amine, the alpha carbon. The prevention may include substituting one or both hydrogens on the alpha carbon. If there are no hydrogens to attack, the degradation reaction pathway described in FIG. 2 cannot proceed. If there are less hydrogens, the amount of attack points within the molecule is lowered or minimized. The hydrogen substitution may thus impede the abstraction of H atom from the monomer and consequently the degradation of the sorbent. The substitution thus reduces the probability that the H atom may separate and react with O₂impeding the initialization of the degradation process. In parallel, a well-chosen modification can increase the activation energy of the H abstraction reaction, further suppressing the first step of the degradation process.

However, substitution of hydrogens on the alpha carbon also influences the binding energy of CO₂ in a negative way. In general, when the binding energy of CO₂ becomes weaker, the sorbent becomes less functional for CO₂ capture.

### Materials choice and screening

FIGS. 3A-T shows the chemical structures of the monomers that include modified polymeric sorbents (FIG. 3C-FIG. 3S) and prior art sorbents (FIG. 3A, FIG. 3B, and FIG. 3T).

A first-principles DFT model was prepared to screen the 20 representative modifications to the sorbent shown in FIGS. 3A-3T for (I) susceptibility to oxidative degradation and (II) CO₂ capture properties.

(I) The initiation of oxidative degradation can be suppressed by reducing the number of hydrogens on the carbon adjacent to the amine by replacing one or two of the available hydrogens by different functional groups (as is shown in FIGS. 3A-3T). Simultaneously, the rate of the reaction can be reduced by increasing the activation energy of the degradation reaction or reducing the stability of the peroxide intermediate.

(II) The CO₂ binding energy of the sorbent determines the ability of the sorbent to capture CO₂ from dilute gas sources. The less negative the binding energy, the higher concentration of CO₂ is required for effective adsorption.

The ability of the sorbents to capture carbon dioxide was studied in terms of CO₂ binding energies (a). Degradation of the sorbent was examined in terms of (b) the binding energy of peroxide, a key degradation intermediate, representing its stability, and (c) the activation energy of the hydrogen abstraction from the carbon atom next to the amine functional group, initializing the degradation process. All energies were obtained from the quantum chemical calculations with configurations representative of the corresponding materials.

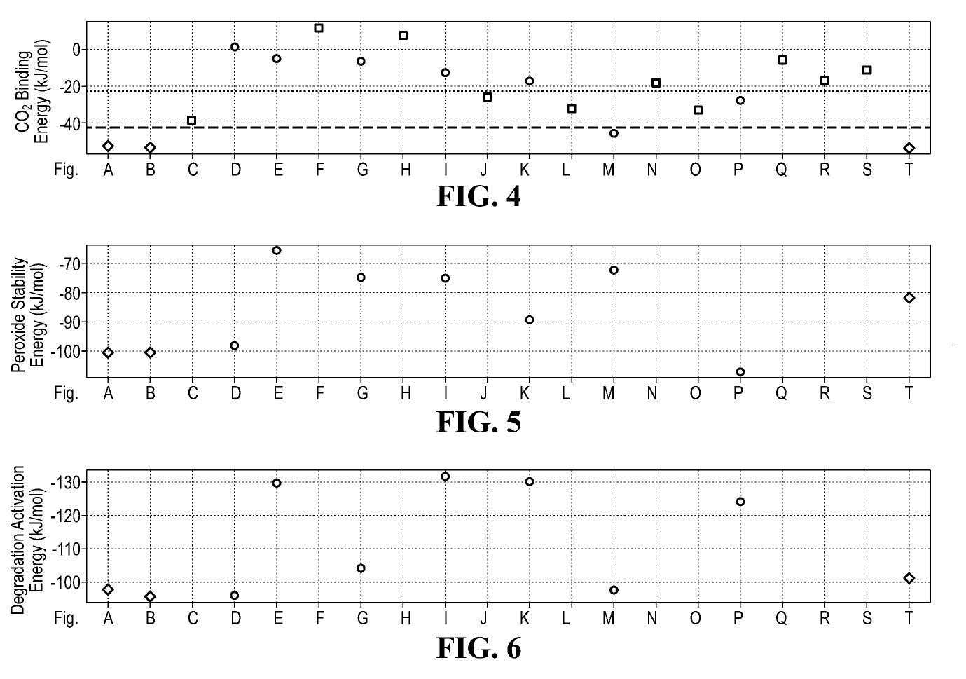

FIG. 4 shows screening of the modified polymeric sorbents with side chain structures shown in FIG. 3C-3S compared against state-of-the-art sorbent of FIG. 3A, and prior art of FIG. 3B and 3T, according to (a) the CO₂ binding energy.

FIG. 5 shows screening of the modified polymeric sorbents with side chain structures shown in FIG. 3C-3S compared against state-of-the-art sorbent of FIG. 3A, and prior art of FIG. 3B and 3T, according to (b) the stability of the key degradation intermediate, peroxide.

FIG. 6 shows screening of the modified polymeric sorbents with side chain structures shown in FIG. 3C-3S compared against state-of-the-art sorbent of FIG. 3A, and prior art of FIG. 3B and 3T, according to (c) the activation energy of the degradation.

In FIGS. 4, 5, and 6, the circle markers represent sorbents in which one or more hydrogens are available on the carbon adjacent to amine, the square markers represent sorbent in which both hydrogens were substituted. Since both hydrogens were substituted, there is no point of attack left in the compounds of the square markers. The diamond markers represent prior art sorbents. The dashed line indicates the threshold CO₂ binding energy for optimal performance in a direct air capture application while the dotted line indicates a threshold binding energy for optimal performance in a concentrated CO₂ capture application.

### Discussion

Ideally, to bind CO₂, the alpha carbon should have a small charge and appear close to the bottom of the graph of FIG. 4, as is shown for the prior art materials. But the materials with charge close to 0 also have a small activation energy for hydrogen abstraction and are more susceptible to oxygen attack and degradation. Hence, there is a need to identify an optimal candidate with good CO₂ binding capability as well as good resistance to degradation.

While substitution of hydrogen atoms on the carbon adjacent to the amine with halogens (Cl, Br, F) slowed down the degradation process significantly, both by decreasing the number of hydrogens on the carbon and increasing the oxidation activation energy (FIG. 6), the halogen substitution also resulted in diminished ability to effectively bind CO₂ from dilute sources (FIG. 4).

Another effective way to stop the degradation process would be to substitute both hydrogen atoms on the carbon adjacent to the amine eliminating the possibility to initialize the abstraction of hydrogen atoms representing degradation process. Among sorbents modified with two substitutions, benzylamine with two methyl groups (FIG. 3C), with two hydroxides (FIG. 3L), and with a methyl group and carboxylic acid (FIG. 3O) showed the best results for carbon capture (FIG. 6). However, their CO₂ binding energies still differ from the original sorbent by more than 10 kJ/mol (FIG. 4) suggesting that their ability to bind CO₂ may not be strong enough for a direct-air capture application. They may be suitable for CO₂capture from more concentrated sources, e.g. flue gas.

CO₂ binding energies of benzylamine with a methyl group (FIG. 3B), a carboxylic acid (FIG. 3M), and secondary amine (FIG. 3T) are within 10 kJ/mol of the original sorbent (FIG. 3A), leading to their effective carbon capture even from ambient air (FIG. 4). While they all have degradation activation energy close to the original sorbent (FIG. 3A), kinetics of the degradation will still slow down with methyl benzylamine (FIG. 3B) and carboxyl benzylamine (FIG. 3M) because only one hydrogen atom on the carbon is available to initialize the degradation, lowering the probability of the reaction to happen and consequently reducing the reaction rate constant by 50%. Furthermore, in the case of carboxyl benzylamine (FIG. 3M), the peroxide intermediate is substantially less stable (+30 kJ/mol) than in the case of methyl benzylamine (FIG. 3B) (FIG. 5), suggesting that with this substituent, the peroxide formation reaction is thermodynamically less favorable. These results thus indicate that carboxyl benzylamine (FIG. 3M) substitution can effectively slow down the degradation of the sorbent by penalizing the initial peroxide formation step, all while retaining a sufficiently strong binding energy for CO₂ for use in DAC applications.

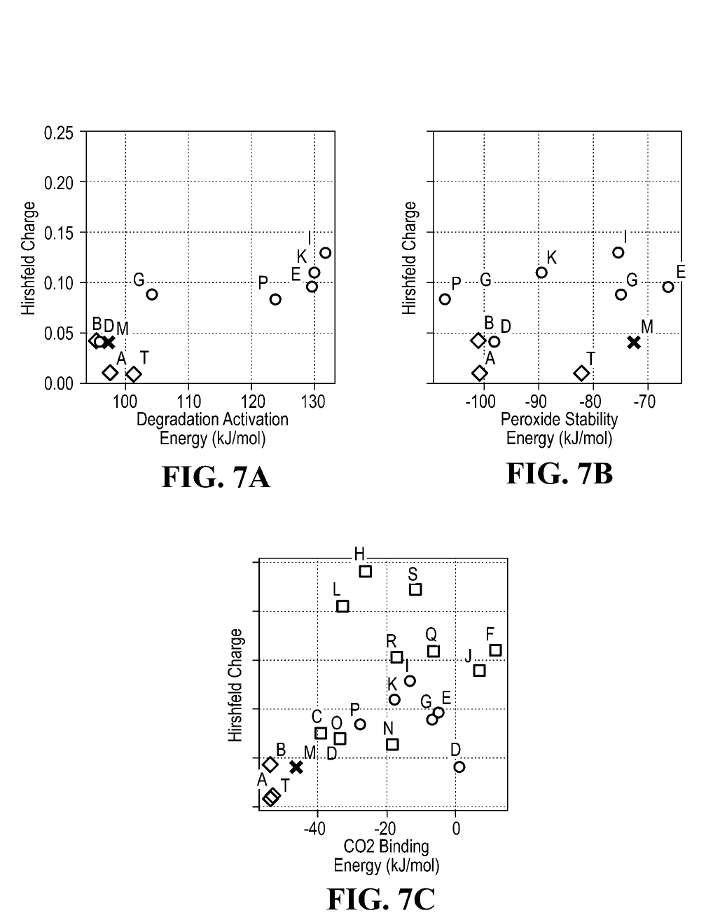

One unifying trend that rationalizes the tradeoff between the activation energy for oxidative degradation and CO₂binding energy is the impact of the substituent functional groups on the charge of the central carbon atom. FIGS. 7A-7C show the correlation between the charge of the carbon atom adjacent to the amine functional group, sorbent durability as measured by the activation energy of the first step in the oxidative degradation process, and CO₂ binding energy.

In FIGS. 7A-7C, the circle markers represent sorbent in which one or more hydrogens are available on the carbon adjacent to amine, the square markers represent sorbent in which both hydrogens were substituted. The diamond markers represent prior art sorbents. The “x” markers represent carboxyl benzylamine-based sorbent.

On average, the activation energy for degradation increases (FIG. 7A) while the CO₂ binding energy decreases (FIG. 7C) with increasing charge on the carbon next to the amine. The stability of the peroxide intermediate does not show a clear trend (FIG. 7B). Nonetheless, there is a general tradeoff in the durability of the sorbent and its ability to bind CO₂. A highly electronegative substituent such as fluorine (FIG. 3I) leads to a very large positive charge on the carbon, increasing the degradation activation energy, but also decreasing the CO₂ binding energy. A relatively neutral substituent such as methyl (FIG. 3B) has minimal impact on the charge of the carbon atom, and thus does not modify the CO₂ binding energy or the degradation activation energy, improving sorbent durability solely by decreasing the number of hydrogens available for oxidation.

The trends shown in FIGS. 7A-7C demonstrated that the charge of the carbon atom is a unifying descriptor to categorize potential modification for the sorbent. Based on these trends, the charge should be minimized to ensure effective CO₂ absorption, but charge should be also maximized to impede the degradation process. This tradeoff rationalizes the choice of sorbent modification known in the prior art, methyl amine (FIG. 3B). The screening identified carboxyl benzylamine (FIG. 3M) as another substituent satisfying the design requirements: keeping the carbon charge relatively low, retaining a high CO₂ binding energy, and improving sorbent durability by reducing the number of reactive hydrogens, albeit with no increase in the activation energy for oxidation.

Additionally, carboxyl benzylamine (FIG. 3M) substitution exhibited two benefits independent of the metrics described previously. First, carboxyl benzylamine unexpectedly destabilized the peroxide oxidation product, which suggested that the oxidation process may be impeded by generally decreasing the peroxide concentration in the system. This effect is independent of the carbon charge and may be related to the geometry of the chemical system. Second, carboxyl benzylamine can attract water molecules to the amine and increase the local proton concentration through the formation of carboxylic acid, both of which will accelerate the kinetics of the carbon capture reaction.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A CO₂ sorbent comprising:
a polymeric repeating unit having a backbone and at least one sidechain, the at least one sidechain comprising:
an amine having an alpha carbon adjacent an amine group;
a covalently-bonded linkage between the alpha carbon and the backbone; and
one or two hydrogen substituents on the alpha carbon, the substituents including a halogen, a hydroxyl group, a carboxyl group, an amine group, or a combination thereof,
the sorbent being structured to reversibly bind CO₂.

2. The CO₂ sorbent of claim 1, wherein the sidechain includes one substituent on the alpha carbon.

3. The CO₂ sorbent of claim 1, wherein the one or two hydrogen substituents include a carboxyl group.

4. The CO₂ sorbent of claim 1, wherein the sidechain includes two hydrogen substituents, both substituents having a same chemical composition.

5. The CO₂ sorbent of claim 1, wherein the covalently-bonded linkage includes a carbon bonded to the alpha carbon.

6. The CO₂ sorbent of claim 1, wherein the covalently-bonded linkage includes a benzene ring.

7. The CO₂ sorbent of claim 1, wherein the amine is a primary amine.

8. The CO₂ sorbent of claim 1, wherein the amine is a secondary amine having two alpha carbons such that each alpha carbon includes one or two of the hydrogen substituents.

9. A CO₂ capture system comprising:
a container having
a fluid input;
a fluid output, the fluid including CO₂; and
a sorbent structured to bind CO₂ from the fluid, the sorbent comprising a backbone and a sidechain including an amine with at least one alpha carbon adjacent an amine group and one or two hydrogen substituents on the alpha carbon, the substituents including a halogen, a hydroxyl group, a carboxyl group, an amine group, or a combination thereof.

10. The CO₂ capture system of claim 9, wherein the sidechain includes one substituent on the at least one alpha carbon.

11. The CO₂ capture system of claim 9, wherein the one or two hydrogen substituents include a carboxyl group.

12. The CO₂ capture system of claim 9, wherein the sidechain includes two hydrogen substituents, both substituents having a same chemical composition.

13. The CO₂ capture system of claim 9, wherein the sidechain includes two hydrogen substituents, one substituent including a methyl group and a second substituent including a carboxyl group.

14. The CO₂ capture system of claim 9, wherein the amine is a primary amine.

15. The CO₂ capture system of claim 9, wherein the amine is a secondary amine having two alpha carbons such that each alpha carbon includes one or two of the hydrogen substituents.

16. A CO₂ capture sorbent comprising:
a polymeric repeating unit having a backbone and at least one sidechain, the at least one sidechain comprising:
an amine having an alpha carbon adjacent an amine group, the alpha carbon having one or two hydrogen substituents including a halogen, a hydroxyl group, a carboxyl group, an amine group, or a combination thereof,
the sorbent being structured to reversibly bind CO₂.

17. The CO₂ capture sorbent of claim 16, wherein the sidechain includes one substituent on the alpha carbon, the substituent being a carboxyl group.

18. The CO₂ capture sorbent of claim 16, wherein the sidechain includes two hydrogen substituents, both substituents having a same chemical composition.

19. The CO₂ capture sorbent of claim 16, wherein the amine is a primary amine.

20. The CO₂ capture sorbent of claim 16, wherein the amine is a secondary amine having two alpha carbons such that each alpha carbon includes one or two of the non-hydrogen groups.
